(19) United States
(12) Patent Application Publication
(10) Pub. No.: US 2017/0209985 A1
(43) Pub. Date: Jul. 27, 2017

(54) PURLIN FIXING TOOL

(71) Applicant: WEEKS HOLDINGS PTY LTD, Edinburgh North (AU)

(72) Inventors: Andrew Burnard, Edinburgh North (AU); John Packer, Edinburgh North (AU); Dominic Sean Gillespie, Edinburgh North (AU)

(21) Appl. No.: 15/303,954

(22) PCT Filed: Apr. 2, 2015
(86) PCT No.: PCT/AU2015/000201

§ 371 Date: Oct. 13, 2016

(30) Foreign Application Priority Data
Apr. 15, 2014 (AU) 2014901376
Oct. 21, 2014 (AU) 2014904193

(51) Int. Cl. B25B 5/00; E04B 7/02; E04G 21/18; B25B 5/04

(52) U.S. Cl. CPC B25B 5/003; B25B 5/04; E04B 7/024; E04G 21/1891

(57) ABSTRACT

A tool for fixing purlins to a roof truss including a first rotatable jaw for attaching to a reference purlin and a plurality of spaced apart jaws for holding further purlins that are to be positioned. The tool is rotated to an upright position to accept the purlins to be placed and then rotated such that the purlins are placed on the roof truss in alignment for fixing.

### FIELD OF THE INVENTION

The present invention relates to tools for fixing purlins, in particular a tool for fixing purlins to roof trusses. Whilst the tool is primarily intended for such an application it can also find use wherever a series of elongate members are to be positioned with a consistent spacing such as battens used for attaching cladding to the walls of a building.

### BACKGROUND TO THE INVENTION

Purlins are fixed to roof trusses in order to support roofing material. Purlins may also be known as battens, battening or roofing lath. Where the roofing material is tiles the purlins must be accurately positioned to allow the tiles to attach to the purlins properly. There are also standard minimum distances at which the purlins may be spaced when the roofing material is metal sheets. Purlins may be unwieldy pieces of building material being anything up to 6 metres in length and may require two labourers working cooperatively to manoeuvre and attach them.

Currently the standard practice to attach purlins to the roof trusses is to climb to the apex of the roof truss, and place a single purlin. Then the distance from that purlin to the bottom of the truss is measured and calculations are done and a spacing stick is fashioned or the spacing distance is noted. The purlins are then individually attached to the trusses, starting from the top purlin and working down to the lowest one. Such a process is prone to inaccurate placement of the purlins and is slow to do. In fixing purlins a labourer is placed in a potentially hazardous (fall risk/at height) working environment for an extended amount of time. There are no safety nets to stop him or her falling to the ground if his or her footing is lost. It is desirable to improve the purlin fixing process by making it quicker and more accurate and to provide a fall protection means or fall barrier, without the use of scaffolding or harnesses, both of which are expensive.

The object of this invention is to provide an adjustable purlin fixing tool that is both accurate and quick and easy to use easy, and which improves the safety of the user, or at least provides the public with a useful alternative.

### SUMMARY OF THE INVENTION

In a first aspect the invention comprises a tool for fixing purlins, comprising an elongate member with a plurality of jaws attached along its length, wherein a first jaw of the plurality of jaws is rotatable with respect to the elongate member.

Preferably the remainder of the plurality of jaws are movable along the elongate member with respect to the first jaw and fixable in discrete locations.

In preference the tool further comprises a locking member to prevent rotation of the first jaw and the first jaw may be locked in a number of discrete positions.

The tool may further comprise a threaded shaft to which the moveable jaws are mounted, wherein the threaded shaft comprises a plurality of segments each having a different thread pitch. These segments may be on one integral piece or may be individual rods within the tool. Alternatively a plurality of threaded shafts with the same thread pitch but driven at different speeds may be used.

The tool may further comprise an automated mechanism which allows the user to enter the spacing required for the roofing material being used, and the mechanism will then automatically set the spacing of the plurality of moveable jaws. The automated mechanism may additionally include the requirement for a verification code from the supplier of the purlins to ensure that only genuine product is used with the tool. Without the verification code, the mechanism will lock and the tool will be unable to be adjusted.

Preferably the jaws further include teeth and are movable between a first position in which the teeth do not engage a purlin and a second position in which the teeth engage a purlin or the jaws include a magnet to secure a purlin in place.
The invention further comprises a method of attaching purlins to a set of trusses comprising:
1. Working out the required spacing of the purlins based on the size of the tile being used or the minimum required spacing when roof sheets are being used;
2. Calculating the required position of the first, lowest purlin using the plans and length of the roof truss;
3. Attaching the first purlin in the required position;
4. Setting the plurality of jaws of a tool to the required spacing, either manually or with the aid of an automatic adjustment means;
5. Attaching the tool to the first purlin;
6. Loading the tool with the required number of purlins;
7. Using the tool to place the purlins and attaching the purlins to the set of trusses;
8. Removing the tool from the first purlin and attaching it to the highest installed purlin;
9. Loading the tool with the required number of purlins;
10. Placing the purlins and attaching them to the roof trusses;
11. Removing the tool from the purlin; and
12. Repeating steps 8 to 11 as many times as required.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a perspective view of the purlin fixing tool of a first embodiment of the invention in a loading position with 3 purlins to be fixed relative to a first purlin.

FIG. 2 shows the purlin fixing tool of FIG. 1 in a fixing position.

FIG. 3 is a perspective view of the purlin fixing tool.

FIG. 4 is a side view of the purlin fixing tool with first jaws in a loading position.

FIG. 5 is a side view of the purlin fixing tool with first jaws in a fixing position.

FIG. 6 is a cross sectional view of the purlin fixing tool.

FIG. 7 is a close up cross sectional view of the purlin fixing tool detailing first and second jaws, with a purlin engaged in one of the rotating jaws, and not engaged in the non-rotating jaws.

FIG. 8 is perspective view of the purlin fixing tool of a second embodiment of the invention in a fixing position.

FIG. 9 shows the purlin fixing tool of FIG. 9 with its body hidden.

FIG. 10 shows a close up view of the first movable jaws of the tool of FIG. 8.

FIG. 11 shows a close up view of the pivoting jaws of the tool of FIG. 8.

FIGS. 12A and 12B show cutaway side views of the movable jaws of FIG. 10 in a fixing and a loading position.

### LIST OF COMPONENTS

The various elements of the drawings are identified as follows:
10 purlin fixing tool (first embodiment)
11 body
12 handle
13 locking member
14 (handle locking) lever
15 locking member extremity
21, 22, 23, 24 purlins
30 rotatable jaws
31 jaw aperture
33 pivot bolt
35 locking grooves
39 support member
40, 50, 60 non-rotatable/movable jaws
41, 51, 61 jaw aperture
63 locking screw
64 positioning holes
80, 90 jaw halves
81, 91 pivots
82, 92 tooth
83, 93 intermeshing sections
84, 94 heels
95 handle
96 spring
100 purlin fixing tool (second embodiment)
102 body
104 handle
106 locking knob
107 pivoting member
108 scale window
110 adjustment knob
112 anchor
114, 116, 118 threaded rods
119 anchor
130 rotatable jaws
131 mount
132 first jaw half
133 second jaw half
134 support member
135 crank
136 slide
137, 138 crank pivot points
140, 150, 160 movable jaws
151 sled
142 loading locking hole
143 fixing locking hole
144 body pivot point
152, 153 sled halves
154 jaw mounting plate
155 first half jaw
156 second half jaw
157 threaded nut

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

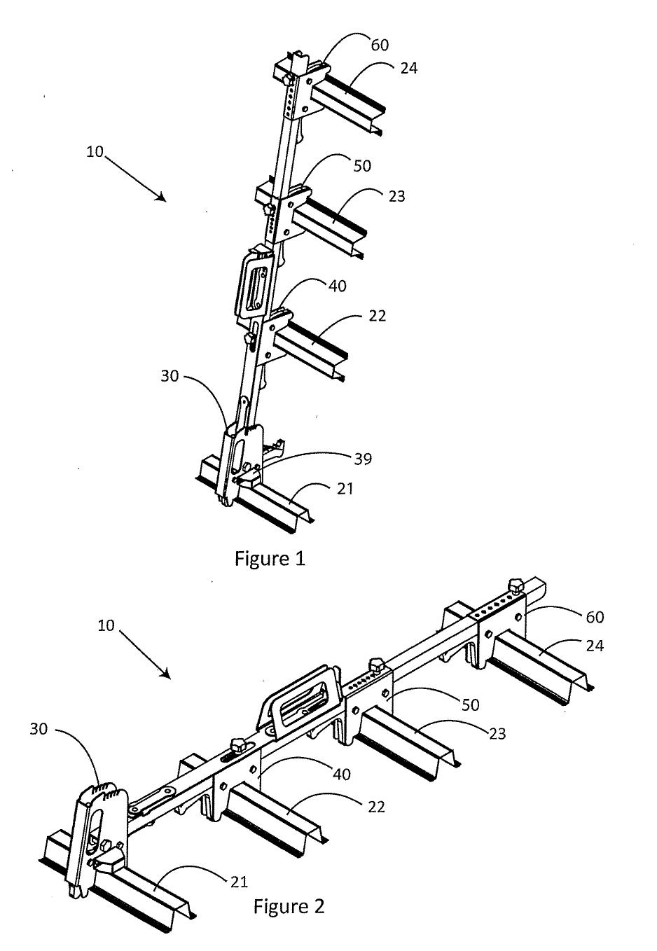

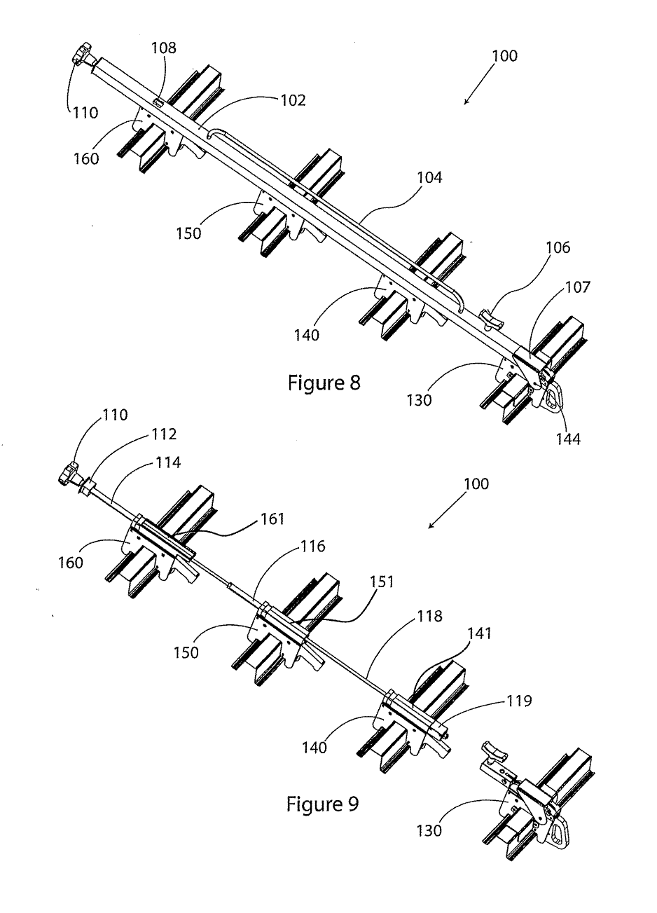

The invention involves a tool which is first attached to a purlin that has already been fixed to a set of trusses, is loaded with three further purlins, and then rotates to place the purlins in a spaced relationship to the first purlin ready to be fixed to the trusses. Two embodiments of the tool are discussed. A first embodiment is illustrated in FIGS. 1 to 7 that allows purlins to be placed at discrete selectable intervals to each other. A second embodiment illustrated in FIGS. 8 to 12B allows a continuous adjustment for setting the spacing between the purlins. The second embodiment will be described in lesser detail than the first embodiment as it incorporates several common features and has a similar mode of operation. The invention further includes a method for fixing purlins using the tool.

The tool has been described with three movable jaws for fitting purlins, however the number of jaws on the tool may be altered, or only some of the jaws operated at one time. The number of jaws present on the tool or that will be used at any one time, will be in part determined by the roofing material used. For example if using roof tiles, the distance between purlin is determined by the size of the tile being used, and the number of jaws that fit on the tool will be determined by the length of the elongate member. The length of the elongate member is not fixed and is only limited by practical considerations such as not making it too long that it becomes unwieldy and therefore adds to the safety concerns when working at height. If the roofing material is metal sheeting then the number of jaws used will be lower as the spacing required is greater than when tiles are the roofing material.

The purlin fixing tool 10 of the first embodiment of the invention is shown in use in FIGS. 1 and 2. A first purlin 21 is manually fitted to the lower edge of a set of roof trusses at a right angle to the roof trusses (not shown). The tool 10 is then positioned to engage the purlin 21 in a first set of jaws 30. Purlins to be fitted, 22, 23 and 24 are placed in jaws 40, 50 and 60 respectively. The tool 10 is then rotated about the first set of jaws 30 until the purlins are located on the roof trusses. The purlins are then attached to the trusses with appropriate fasteners and the tool is then released from the purlins. The process is repeated with the first jaws now placed onto the highest purlin, 24. The process is further repeated until the desired number of purlins have been fitted. The figures show a single tool in use with short lengths of purlins, however, typically purlins may be up to 6 metres in length and often two tools are used simultaneously by two operators, one near each end of the purlins.

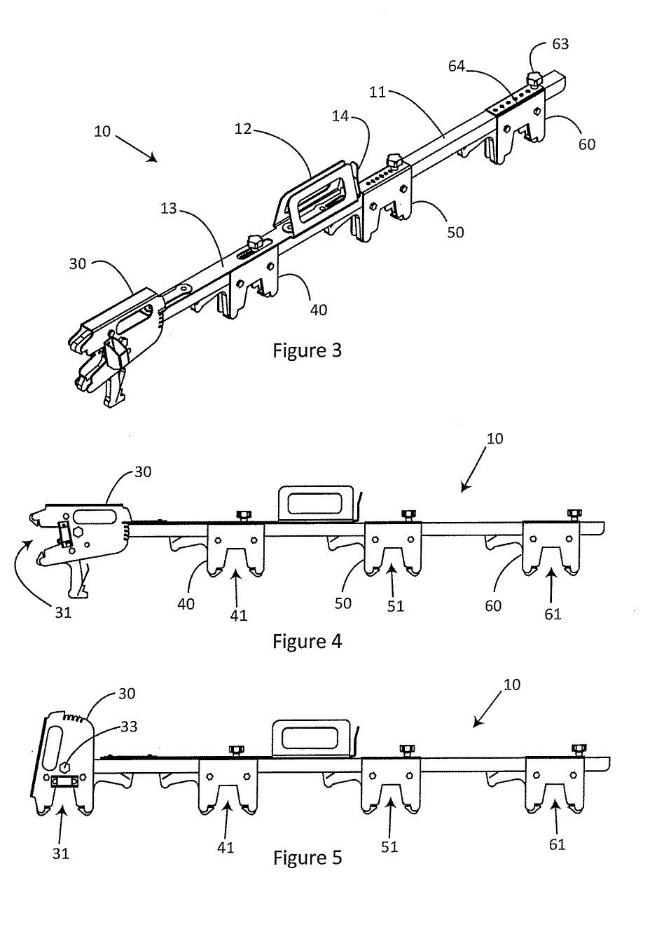

The general structure of the tool 10 can be appreciated with the perspective view of FIG. 3. The tool comprises an elongate body 11 to which a rotatable set of jaws 30 is fixed at a first end and three non-rotatable jaws 40, 50 and 60 which are fitted along the length of the member. More or less non-rotatable jaws could be fitted if desired. The tool pivots about pivot bolt 33 which passes through the first set of jaws 30. A handle 12 is provided to control the rotation of the tool and is slidable along the body 11 to manipulate locking member 13, the extremity of which 15 engages locking grooves 35 of the rotating jaws (best seen in FIG. 7). The tool can thus be secured in the upright position as shown in FIG. 1 whilst the purlins are being loaded. In this position support member 39 serves to stabilise the tool. Lever 14 is used to secure or release the handle. The movable jaws 60 include a series of positioning holes 64 which correspond to a series of threaded holes in the body 11 (which are obscured in the figures). The holes are aligned to select the position of the jaws which are held in place by locking screw 63. A similar arrangement exists for jaws 40 and 50. By moving the jaws different purlin spacings are accommodated. In a simpler embodiment of the invention the jaws are fixed in place.

FIGS. 4 and 5 show the tool 10 from side on with the rotatable jaws 30 in a loading position and a fixing position respectively. In the loading position the first jaw aperture 31 is approximately at right angles to the moveable jaw apertures 41, 51 and 61. In the fixing position all of the jaw apertures are aligned.

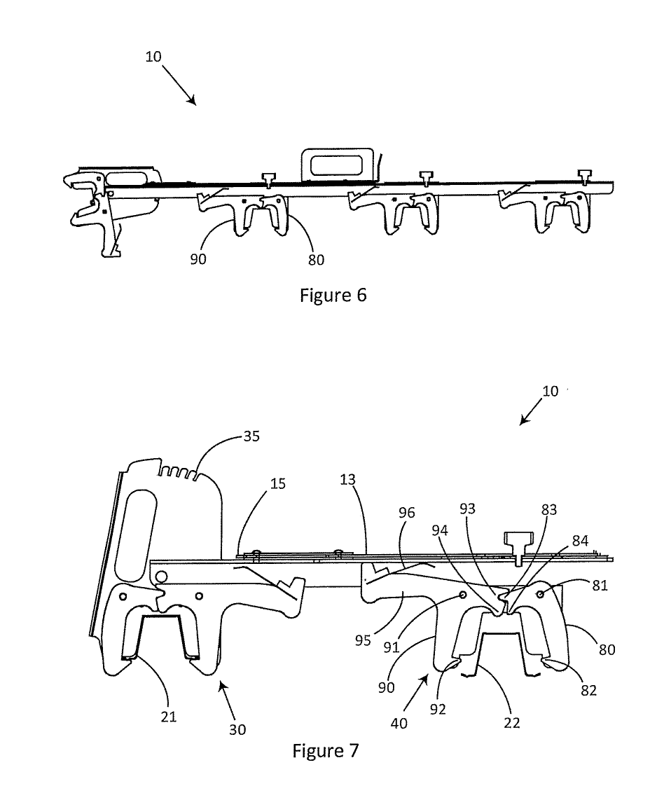

FIG. 6 shows a cross section view along the centreline of the body 11 allowing the inner workings of the jaws to be seen. FIG. 7 is a close up view showing just the rotatable jaws 30 closed with a purlin 21 held in place and the first movable jaws 40 open with a purlin 22 adjacent. The operation of the two jaws is identical (as is that of the remaining jaws). The jaws comprise a first jaw half 80 and second jaw half 90 with teeth 82 and 92 to hold a purlin in place. The jaws are pivotable about respective pivots 81 and 91 and include intermeshing sections 83 and 93 to ensure that the jaw halves move in unison. Heels 84 and 94 help eject the purlin. Spring 96 acts on the handle 95 to bias the jaws shut. An opposing force applied to the handle will open the jaws as will pushing a purlin in towards the teeth 82 and 92.

The second embodiment of the invention is shown as 100 in FIGS. 8 to 12B. The tool 100 is shown in FIG. 8 in perspective view in a fixing position and can be seen to be similar to the tool 10 shown in FIG. 2 in having an elongate body 102 with a first set of rotatable jaws 130 engaging a first purlin 21 and movable jaws 140, 150 and 160 engaging spaced apart purlins 22, 23 and 24. Handle 104 aids in manipulating the tool. The adjustment mechanism is simpler for the user and has knob 110 to adjust the spacing between the purlins and knob 106 for locking the tool in the fixing position or in the loading position. Window 108 reveals a scale on top of jaws 160 indicating the separation of the jaws. The single knob 110 adjusts the spacing of all jaws simultaneously. A pivoting member 107 attaches the body 102 to the rotatable jaws 130 at pivot point 144.

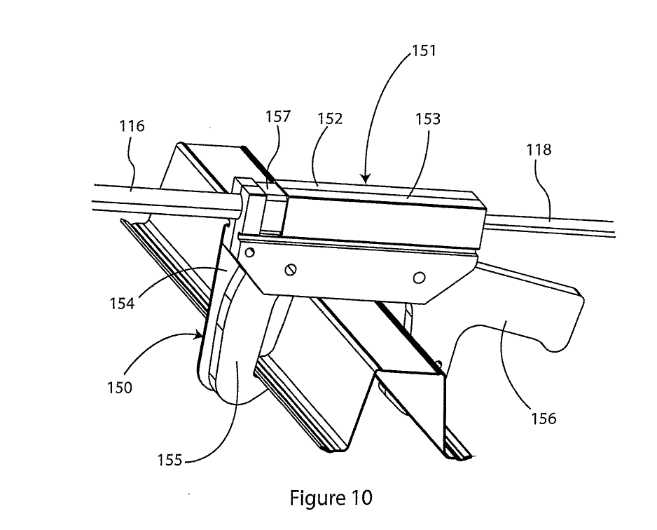

The adjustment mechanism can be seen in FIG. 9 and comprises a series of threaded rods 114, 116 and 118 which pass through sleds 161, 151 and 141 which hold jaws 160, 150 and 140 respectively. The thread pitch of rod 116 is twice that of rod 118 and the thread pitch of rod 114 is three times that of rod 118. As a result when jaws 140 are adjusted by 1 mm, jaws 150 will move by 2 mm and jaws 160 will move by 3 mm. The spacing between each of the jaws is thus adjustable, but kept in unison with each other. The threaded rods are kept in position by anchors 112 and 119 which have a smooth internal barrel to allow the rod to freely rotate.

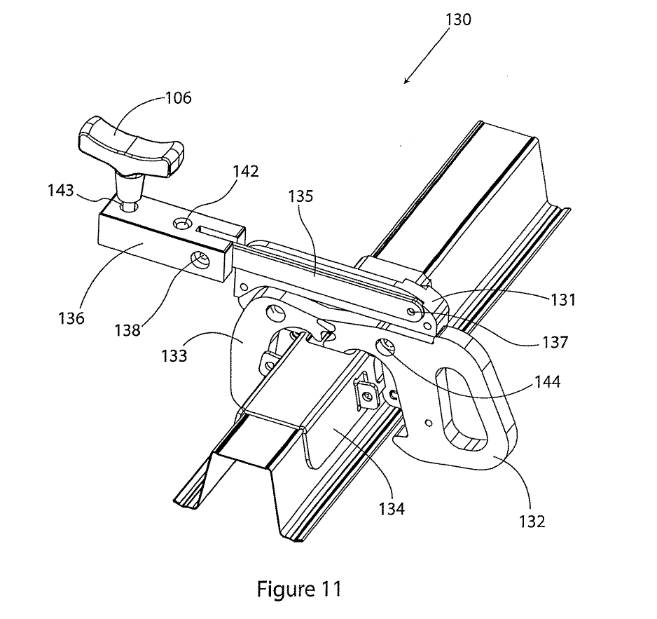

Further details of one set of jaws 150 and sled 151 can be seen in FIG. 10. The sled comprises first and second halves 152 and 153 which cover the threaded rods 116 and 118. A threaded nut 157 within the sled engages with the threaded rod 116 resulting in rotation of the threaded rod translating into linear movement of the sled and attached jaws 150. The jaws comprise first jaw half 155 and second jaw half 156 which operate in a similar manner to those of the first embodiment, but are instead attached to sled 151 via jaw mounting plate 154 (and a further mounting plate not shown).

In a further embodiment (not shown) the threaded rod with multiple segments is replaced with multiple rods operating in parallel. Again each rod has a different pitch to ensure that the separation of each jaw adjusts equally. The rods are connected to ensure that they operate in unison; this may be by intermeshing cogs fitted to the rods, a toothed belt or other suitable means. Alternatively the rods may all have the same thread pitch and be interconnected by a gearing mechanism so that they rotate at different speeds to ensure the jaws adjust equally.

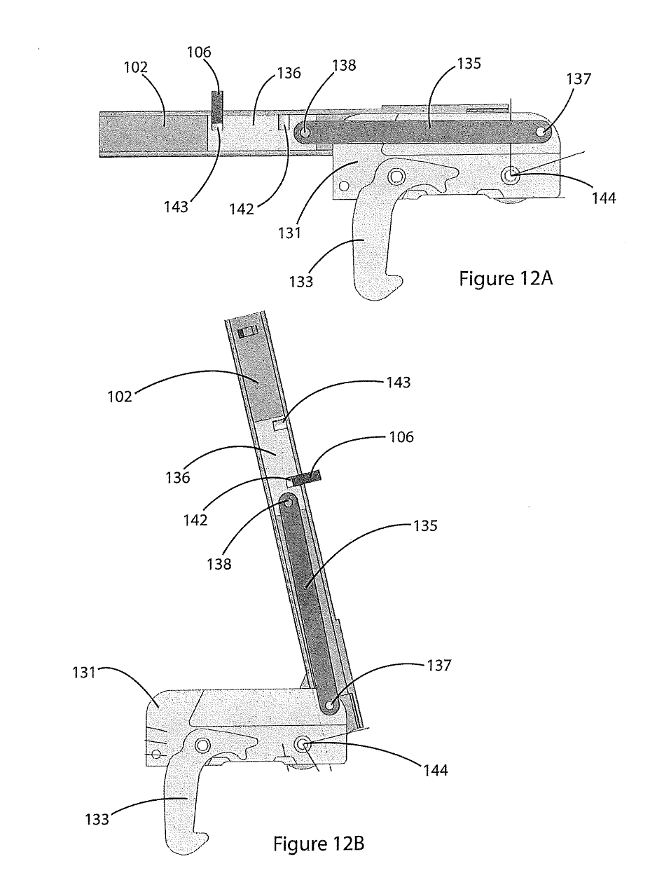

The rotatable jaws 130 are shown in detail in FIG. 11 with the jaw mounting plates removed to reveal the inner details. Similar to the first embodiment, the jaws include first half jaw 132 and second half jaw 133 for clamping the purlin and support member 134 to give the tool some stability when in the loading position. The jaws include mount 131 to which a slide 136 is attached by crank 135. The slide and crank are normally hidden in the tool body 102. As the body is rotated between the loading and fixing positions the piston will move within the body as the crank pivot points 137 and 138 are offset from the body pivot point 144. In the loading position locking pin 106 will align with loading locking hole 142, and in the fixing position with fixing locking hole 143. The locking pin passes through a small hole in the body 102, thus restricting it to a fixed position on the body. The locking pin can therefore only lock the tool in either the loading position or the fixing position. Cutaway side views showing the locking mechanism are to be seen in FIG. 12A in the fixing position and FIG. 12B in the loading position.

In a further embodiment, not shown, the tool is fitted with a control mechanism and an electric motor for moving the jaws wherein the user enters the desired spacing required for the purlins, and the mechanism then sets the spacing of the plurality of moveable jaws. The automated mechanism may additionally include the requirement for a verification code from the supplier of the purlins to ensure that only genuine product is used with the tool. Without the verification code, the mechanism will lock and the tool will be unable to be adjusted.

In a still further embodiment of the tool (not shown) the jaw halves 80, 90 or 155, 156 are replaced with a magnet for holding the purlins in place.

The purlins shown in the drawings are all light gauge steel purlins which are typically “top hat” shaped in cross section. The jaws shown in the drawing have been adapted to accommodate this particular shape. But this invention may be adapted to be used with any purlin material, by adapting the shape of the jaws to match the shape of the purlin material. Purlins are used in wooden framed houses but are rectangular in cross section.

The invention further comprises a method of attaching purlins to a set of trusses using the tool described above, comprising:

1. Working out the required spacing of the purlins based on the size of the tile being used or the minimum required spacing when roof sheets are being used;

2. Calculating the required position of the first, lowest purlin using the plans and length of the roof truss;

3. Attaching the first purlin in the required position;

4. Setting the plurality of jaws of a tool to the required spacing, either manually or with the aid of automatic adjustment means;

5. Attaching the tool to the first purlin;

6. Loading the tool with the required number of purlins;

7. Using the tool to place the purlins and attaching the purlins to the set of trusses;

8. Removing the tool from the first purlin and attaching it to the highest installed purlin;

9. Loading the tool with the required number of purlins;

10. Placing the purlins and attaching them to the roof trusses;

11. Removing the tool from the purlin; and

12. Repeating steps 8 to 11 as many times as required.

This method may be conducted by a single person using a single tool or by two or more labourers using two or more tools.

It should be noted that this method of installing purlins simultaneously provides a fall barrier below and behind the labourer as the purlins are installed. The purlins and the trusses together form a web of material (preferably steel, but possibly wood) and if the labourer were to lose his or her footing, his or her fall would be halted by this web of material.

The reader will now appreciate the present invention which provides a tool for quickly and accurately fixing purlins to a roof truss by attaching to a first reference purlin and providing jaws to hold further purlins at a desired spacing.

The reader will also appreciate that the tool provides an added point of stability for the labourer, that working from the bottom to the top of the roof trusses is a safer method of working and that the web of purlins and roof trusses installed provide a fall barrier to the labourer, thereby improving the safety of the labourer. The tool itself also provides an added stability aid when it is in a locked, raised position, giving the labourer something to hang onto and steady him or herself.

The purlin tool may also be used to fix battens to the side of a structure to which wall cladding is then attached. Whilst this embodiment does not provide the added safety of a fall barrier, it still provides the point of stability for labourers working at height (the top of the wall), with the tool fixed to the lowest batten and being locked in place. Also it allows many battens to be applied more quickly, limiting the time that the labourer is working at height.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A tool for fixing purlins, comprising an elongate body with a plurality of jaws, adapted to hold the purlins attached along its length, wherein a first jaw of the plurality of jaws is rotatable with respect to the elongate body; and wherein a remainder of the plurality of jaws is simultaneously movable along the elongate body with respect to the first jaw.

2. A tool as in claim 1 wherein the plurality of jaws is fixable in discrete locations.

3. A tool as in claim 1 further comprising a locking member to prevent rotation of the first jaw.

4. A tool as in claim 3 wherein the first jaw may be locked in a number of discrete positions.

5. A tool as in claim 1 further comprising a threaded shaft to which the moveable jaws are mounted, wherein the threaded shaft comprises a plurality of segments each having a different thread pitch.

6. A tool as in claim 1 further comprising a plurality of threaded shafts corresponding to each of the moveable jaws.

7. A tool as in claim 6 wherein each of the threaded shafts has a different thread pitch.

8. A tool as in claim 6 wherein each of the threaded shafts has the same thread pitch.

9. A tool as in claim 1 wherein the jaws further include teeth and are movable between a first position in which the teeth do not engage a purlin and a second position in which the teeth engage a purlin.

10. A tool as in claim 1 further comprising a magnet to secure a purlin in place.

11. A tool as in claim 1 further comprising an electric motor and control system for moving the jaws.

12. A tool as in claim 11 wherein the control system is enabled by the entry of a verification code.

13. The invention further comprises a method of attaching purlins to a set of trusses using the tool as defined in claim 1, wherein the method comprises:
a. working out the required spacing of the purlins based on the size of the tile being used or the minimum required spacing when roof sheets are being used;
b. calculating the required position of the first, lowest purlin using the plans and length of the roof truss;
c. attaching the first purlin in the required position;
d. simultaneously setting the plurality of jaws of a tool to the required spacing, either manually or with the aid of automatic adjustment means;
e. attaching the tool to the first purlin;
f. loading the tool with the required number of purlins;
g. using the tool to place the purlins and attaching the purlins to the set of trusses;
h. removing the tool from the first purlin and attaching it to the highest installed purlin;
i. loading the tool with the required number of purlins;
j. placing the purlins and attaching them to the roof trusses;
k. removing the tool from the purlin; and
l. repeating steps h. to k. as many times as required.
